(19) United States
(12) Patent Application Publication
(10) Pub. No.: US 2013/0226832 A1
(43) Pub. Date: Aug. 29, 2013

(54) Computerized System and Process for Financial Planning

(71) Applicant: Allianz Asset Management of America L.P., (US)

(72) Inventor: Glenn Dial, Windermere, FL (US)

(73) Assignee: Allianz Asset Management of America L.P., Newport Beach, CA (US)

(21) Appl. No.: 13/773,092

(22) Filed: Feb. 21, 2013

Related U.S. Application Data
(60) Provisional application No. 61/602,453, filed on Feb. 23, 2012.

(51) Int. Cl. G06Q 40/06

(52) U.S. Cl. CPC G06Q 40/06
USPC 705/36 R

(57) ABSTRACT

A computerized process for determining and recommending a type of target-date fund, such as “to” funds and “through” funds, for a retirement savings plan. The process can include the steps of receiving, by a computing device, data from a user, determining, by the computing device, a recommended type of target-date fund based at least in part on the received data, and outputting the recommended type of target-date fund for presentation to the user.

### CROSS-REFERENCE TO RELATED APPLICATIONS

This application claims the benefit of U.S. Provisional Application No. 61/602,453, filed Feb. 23, 2012, which is hereby incorporated by reference in its entirety.

### BACKGROUND

1. Field

Embodiments of the present invention relate generally to systems and processes for financial planning, and more particularly, but not by way of limitation, to systems and processes for determining and recommending a type of investment vehicle fix a specific retirement savings plan.

2. Background

According to the Employee Benefit Research Institute, more than 40% of Americans are estimated to be at risk for retirement income shortfall. One challenge for retirement plan sponsors is the fact that many defined contribution (“DC”) plan participants lack the time, interest and/or investment knowledge to direct their retirement savings and income approach. To some participants, the choices available in constructing their own investment portfolios can be overwhelming. For example, a participant may be expected to choose from one or more of the following funds: money market or stable value funds, bond funds, small, medium, or large cap core funds, cap value funds, or cap growth funds, as well as international funds. As a result, many participants encounter significant difficulties building their own investment portfolios.

In an attempt to alleviate these difficulties, the U.S. Department of Labor (DOL) has granted default status to funds known as “target-date funds,” by categorizing them as Qualified Default Investment Alternatives (QDIAs) under the Pension Protection Act of 2006 (PPA). A typical target date fund is designed with an investment strategy based on the year the participant plans to retire. For example, target-date funds can be available based on 5-year increments, such as a 2015 Target-Date Fund, a 2020 Target-Date Fund, a 2025 Target-Date Fund, etc.

Even though target-date funds have been given default status under the PPA, the mere act of choosing a target-date fund does not insulate plan participants from market turmoil. For example, in 2008 and early 2009, differences among target-date fund families added up to losses of between 9% and 41% for 2010 target-date funds. Participants who had invested in 2010 funds, and were by definition at or near retirement, were hit hard by market sequencing risk, which is the risk of retiring in the wrong market cycle. These concerns have led to renewed debate and increased scrutiny from regulators relating to target-date funds.

For at least these reasons, there is a desire for improved systems and processes for financial planning, and more particularly, for improved systems and processes for determining and recommending a type of investment vehicle for a retirement savings plan.

### BRIEF SUMMARY

In one embodiment, a computerized process for determining and recommending a type of investment vehicle for a retirement savings plan includes: receiving, by a computing device, data from a user including at least the following: (a) information about the purpose of the savings plan, (b) predicted actions of participants in the savings plan, (c) previous actions of the participants, (d) an administrator's ability to administer payment to participants, (e) the participants' knowledge to set up their own withdrawal plan, (f) the extent to which the participants can handle market losses in their accounts near or at retirement, and (g) whether participants also participate in other employer-sponsored retirement plans. The process further includes determining, by the computing device, a recommended type of investment vehicle for a specific retirement savings plan based at least in part on the received data, and outputting, for example by a computing device, the recommended type of investment vehicle for a specific retirement savings plan for presentation to the user. In one embodiment, the step of outputting can include outputting in the form of at least one of written or electronic presentation to the user. In one embodiment, the type of investment vehicle for a retirement savings plan can include, but is not limited to a target-date fund. The recommendation can be limited to a type of target-date fund. In some embodiments, no other investment vehicles are recommended and/or included as output. In some embodiments, the Advisor and Plan Sponsor hold the ultimate responsibility for using the output to determine the appropriate investment vehicle.

In one embodiment, a computerized process for determining and recommending a type of investment vehicle for a specific retirement savings plan includes: receiving data from a user including at least information about whether a primary purpose of the target-date fund is to accumulate funds that can be used as income or provide optionality at retirement, or whether the primary purpose of the target-date fund is to both accumulate assets and automatically provide lifetime income to participants during their retirement years. The process can include providing a recommendation for a “to” target-date fund when the received data indicates that the primary purpose of the target-date fund is to accumulate funds that can be used as income or provide optionality at retirement. The process can include providing a recommendation for a “through” target-date fund when the received data indicates that the primary purpose of the target-date fund is to both accumulate assets and position the assets for continued growth during retirement or automatically provide lifetime income to participants during their retirement years.

The process can include requesting additional information from the user when the received data indicates that the primary purpose of the target-data: fund is to both accumulate assets and automatically provide lifetime income to participants during their retirement years. In some embodiments, the process requires that a user answer a full set of questions in order to receive a recommendation for a “to” target-date fund or a “through” target-date fund. In other embodiments, the user need only answer some of the questions before receiving a recommendation.

Additional features of the invention will be set forth in the description that follows, and in part will be apparent from the description, or may be learned by practice of the invention. Both the foregoing general description and the following detailed description are exemplary and explanatory and are intended to provide further explanation of the invention.

### BRIEF DESCRIPTION OF THE FIGURES

The accompanying figures, which are incorporated herein, form part of the specification and illustrate exemplary embodiments of the present invention. Together with the description, the figures further serve to explain the principles of; and to enable a person skilled in the relevant arts) to make and use the exemplary embodiments described herein.

FIG, 1 illustrates a chart showing several exemplary target-date funds based on the amount of equity they contain compared to their risk near retirement age,

FIG. 2 is a flowchart illustrating steps of a process in accordance with an embodiment of the present invention.

FIG. 3 depicts an example computer system in which embodiments of the present invention may be implemented.

FIG. 4 depicts an example computer system in which embodiments of the present invention may be implemented.

FIG. 5 depicts an example computer system in which embodiments of the present invention may be implemented.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate software module. One skilled in the relevant arts will understand that the functionality of modules may be defined in accordance with a number of stylistic or performance-optimizing techniques, for example.

### 1. INTRODUCTION

Selecting an appropriate target-date fund can be a complex undertaking. Asset allocation funds, including lifestyle/risk-based funds (such as “conservative”, “moderate”, or “aggressive” funds), are often used as part of retirement savings plans. These funds can include multiple asset classes and can contain any number of underlying funds, which in some cases can simplify the investment process for participants. In particular, these funds can include default investments including a mix of asset classes consistent with capital preservation, longer-term capital appreciation, or a blend of both. As one example, an asset allocation fund can include anywhere from 7 to 20 underlying funds. Participants can predict how much risk they would like to take and put all of their money into a single conservative, moderate, or aggressive fund.

However, many participants may fail to adjust to a more conservative allocation as they approach retirement age and their tolerance for risk typically decreases. A target-date fund can account for a participant's goal retirement age by adjusting to become more conservative as the participant nears retirement age. Such target-date funds have become increasingly popular in recent years. Their increased popularity can be attributed to their QDIA status, simplicity, age-based auto-asset allocation, prevalence in employer DC plan investment menus, shifts in retirement savings responsibility based in part on longer life expectancies, volatile capital markets, an evolution from defined benefit plans to defined contribution plans, as well as uncertainty around Social Security.

Despite the advantages of target-date funds, there is still a great deal of division between investment philosophies. Per the QDIA guidelines, QDIA's must be diversified as to minimize the risk of large losses. However, the retirement industry has not agreed upon a definition of how much risk a given fund should take at retirement age. As a result, some target-date funds invest up to 65% of a participant's money in stocks at retirement, while others invest only a moderate amount in stocks, such as 25%, at retirement age.

### 2. “TO” TARGET-DATE FUNDS AND “THROUGH” TARGET-DATE FUNDS

As a result, target-date funds are often grouped into two types: “to retirement” target-date funds and “through retirement” target-date funds (which are also known simply as “to” funds and “through” funds, respectively). Generally speaking, “to” funds are designed to manage retirement funds until retirement, whereas “through” funds are designed to manage retirement funds throughout retirement. That is, “through” funds can be designed with the intent that participants will keep their account balances in the plan during retirement.

In general, “to” funds can allow for lower portfolio risk levels near retirement and can also help maximize the purchase of retirement income units (for example, annuity-type solutions) at retirement. “To” funds can additionally help shield participants from the impact of market sequencing risk at a time when their accumulated DC plan savings can least absorb the impact of a large market decline. Some “to” funds can be used to solve for inflation risk, provide for a low level of risk at retirement and require only a low level of administration for the plan sponsor. In contrast, “through” funds tend to compensate for inflation risk, leave the participant more open to market sequencing risk, provide for a middle- to high-level of risk at retirement, and generally entail a middle- to high-level of administrative requirements.

When participants still have 15 years or more until they retire, the glide paths of “to” and “through” funds can look similar. A divergence in risk philosophies can occur about 5 to 10 years before a participant retires. At this stage, “to” funds can become more conservative and less volatile than “through” funds.

Although there is no industry-standard definition for “to” funds and “through” funds, different approaches can be used to classify the funds. As one example, a “to” fund can be classified as a retirement savings fund designed so that the equity glide path (for example, the fund's mix of stocks and bonds) plateaus at the goal retirement age, regardless of the amount of equity composition or risk at the goal retirement age. Under this approach, a “through” fund, in contrast, can be a fund designed to continue to shift its glide path after retirement. As another example, a “to” fund can be classified as a fund that is designed so that it does not exceed a certain amount of equity when the participant is 65 years old, for example no more than 40%. Such a definition is generally insufficient, though, because glide paths can plateau at significantly different risk levels.

As another example, a “to” fund can be classified based on the preferred amount of “risk” in the fund when the participant is 65 years old. “Risk” can be determined, for example, by an annual amount of standard deviation. As another example, a “to” fund can be classified as a fund that is designed to adopt a more conservative investment position at or near a participant's retirement age. Under this approach, a “through” fund, in contrast, can be classified as a find that is designed to adopt a more conservative investment position a number of years after a goal retirement age. As another example, a “to” fund can be classified as a fund that is designed to allow for less risk as a participant approaches or is at retirement. Under this approach, a “through” fund, in contrast, can be classified as a fund that is designed to be more aggressive in its risk level at or near retirement.

For example, FIG. 1 illustrates a chart showing several target-date funds based on the amount of equity they contained and how much risk they took (as measured by annual standard deviation) at retirement. This chart shows data for 2015 Target Date Funds as of Dec. 31, 2011. Generally speaking, the funds in the proximity of the southwest quadrant exhibit traits consistent to that of “to” funds, while the funds in the proximity of the northeast quadrant exhibit traits consistent with “through” funds.

### 3. FACTORS FOR DETERMINING TARGET-DATE FUNDS

The investment strategy a participant uses to generate retirement income can determine which type of investment vehicle would be most appropriate during their working years. Given the variability in available funds, plan sponsors can consider funds based on several factors, such as the purpose and/or goals of the savings plan for one or more of the participants, as well as other factors described herein. Additional factors can include those directed to retirement funds in general such as fees, performance, peer ranking, manager tenure, Morningstar® Style, and whether the fund is an alpha or beta fund. Additional factors can include factors directed to target-date funds in particular, such as any unique fees, glide path design, the number of asset classes, the percent of equity at retirement date, the last strategic modification to glide path, the type of investment vehicle for a specific retirement savings plan, such as “to” funds or “through” funds, the number of underlying funds, risk-adjusted return, and the previous or planned behavior of one or more of the participants. As one example, a plan sponsor can predict participant behavior by considering how similar participants in similar companies act.

In addition, the plan sponsor can consider the difference in target-date equity allocations between the funds, such as each fund's percentage allocated to equity. In general, higher percentages of equity are accompanied by higher levels of risk. Another factor that can be considered is that few participants tend to stay in DC plans after retirement. In particular, studies show that the vast majority of DC plan participants leave their plans within three years of retirement by using IRA rollovers or taking cash distributions, for example.

A plan sponsor can be responsible for a wide range of participants with varying degrees of investment knowledge. As a result, the plan sponsor can consider whether each individual can be deemed a “delegator.” A delegator can be considered a participant who does not have the time, inclination, and/or investment expertise to make their own asset allocation decisions throughout the accumulation cycle.

### 4. COMPUTERIZED SYSTEM AND PROCESS FOR FINANCIAL PLANNING

Any or all of the :factors described herein can be used to help determine and recommend a specific target-date fund or type of investment vehicle for a specific retirement savings plan. By using the computerized system and process for financial planning described herein, a user, such as a plan sponsor and/or a plan participant, or an advisor to a plan sponsor and/or plan participant, can systematically evaluate what type of investment vehicle for a specific retirement savings plan (for example, a “to” fund versus a “through” fund) may be appropriate This can narrow down the universe of target-date funds to the funds that most closely match the plan sponsor's goals and objectives, the participant's “behavior patterns,” or any of the other factors or considerations described herein. In some embodiments, the process can additionally or alternatively recommend a specific fund based on this information.

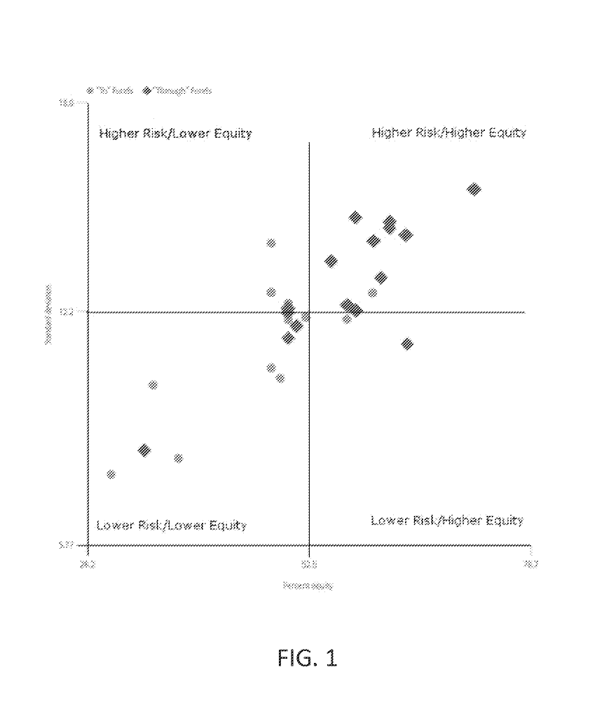

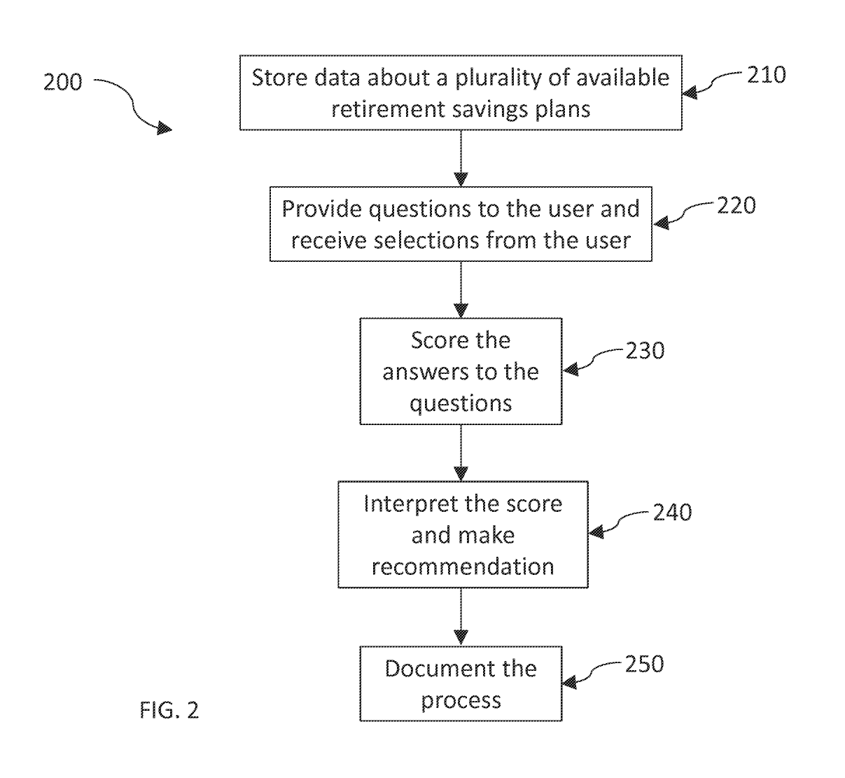

FIG. 2 illustrates a flowchart for a computerized system and process 200 for financial planning. Process 200 includes the step 210 of storing data about a plurality of available retirement savings plans. This data can be stored in, for example, a memory of a user device. This data can include specific plan details, as well as a category into which each specific plan falls. Such data may be stored in a database structure, and may ire categorized based on whether the plan is considered as a “to” or “through” fund. The data may be entered by a user, or may be received from an external source. The data may be updated periodically,

Process 200 further includes the step 22.0 of providing questions to the user and receiving selections from the user to help the system recommend a specific or type of investment vehicle for a specific retirement savings plan. In this step, the user is first presented with several questions to help determine a recommended retirement savings strategy. In some embodiments, for each question the user can select the statement they most strongly agree with. For example, a first question can be directed to information about the purpose of the savings plan. For example, the question can ask: “What is the purpose of your DC Plan?” Two possible answers can include: A. It's a vehicle to accumulate savings during a participant's working years” and B. It's a vehicle to accumulate savings during a participant's working years and to distribute savings during retirement.” Further details regarding the questions to be answered are provided in the examples below.

According to an embodiment, the questions are provided to the user through a computerized user interface. For example, the questions may be displayed either sequentially or in list form on a screen viewable by a user. User selections may be received via an input device, such as a mouse, keyboard, touch screen, etc. For example, a radio button or check box may be provided next to each multiple-choice answer. Alternatively, a text box may be provided for the user to enter the desired answer (e.g., by typing “A” or “B”). In one embodiment, a user must answer all questions before being provided with a recommendation. In another embodiment, a determination is made after each question regarding whether a recommendation can be made or whether further information is needed. An example of each of these embodiments is provided in further detail below (examples 1 and 2, respectively).

If questions are displayed sequentially, the user may be prompted after each question to indicate that the user is ready to proceed to the next question. For example, the user may be prompted to select a “continue” icon when the user is ready to move to the next question. If the questions are displayed in list format, the user may be prompted to indicate that the user has completed the set of questions. For example, the user may be prompted to select a “submit” icon when the user has completed the questionnaire.

Process 200 further includes the step 230 of scoring the answers to the questions. For example, in some embodiments, different questions can have equal or different point “scores” depending on the importance of the question to the recommendation. As one example, an answer relating to the predicted actions of a participant in the savings plan can be worth twice as much as an answer relating to the administrators ability to administer payment to the participant. The weight of each question may or may not be made available to a user, in one example, each question can be allocated a predetermined total number of points. A user can then select a single predetermined response to each question, with the system allocating all the points for that question to the response. In another example, the user can allocate points according to how strongly they agree with each predetermined response to the question. For example, for a question worth 10 points, a user can allocate 7 of the 10 points to a first predetermined response and 3 of the 10 points to a second predetermined response.

In an embodiment where a user must answer all questions provided before a score is generated, the answers may be organized into columns or other organizational structure. A score can be assigned to a column (for example, a column labeled “A” or “B”) that corresponds to the user's answers (for example, answers labeled “A” or “B”). After the user has completed the question portion of the process, the scores for each column can then be calculated by, for example, totaling the scores. One of skill in the art will recognize that other ways of calculating and tallying weighted scores may also he used without departing from the spirit and scope of the present invention.

In an embodiment where a determination is made after each question as to whether a particular answer is dispositive of a particular recommendation, scoring merely involves evaluating whether or not a dispositive answer has been received.

Process 200 further includes the step 240 of automatically providing feedback to the user based on the score. In an embodiment, this feedback includes making a recommendation based on the score. The recommendation can be provided by itself or can include information associated with the recommendation, such as the reasoning or analysis behind the recommendation. For example, in conjunction with a recommendation for a “through” fund, the system may display text such as: “A target-date fund that manages ‘through’ retirement might provide participants a greater chance of not outliving their savings,” In an alternative embodiment, the recommendation is not provided to the user. Instead, the calculated score is provided to the user without a recommendation so that the user can make their own decision as to an appropriate fund. The system can automatically display text in conjunction with such information to facilitate the use of the information in making a decision.

The system can also display other information related to the decision process. For example, if the process is directed to recommending a type of investment vehicle for a specific retirement savings plan (such as a “to” fund or a “through” fund) rather than a specific target-date fund, the plan sponsor and/or participants can be informed that the process is not intended to provide fiduciary investment advice to any plan, plan fiduciary, participant or other party. The plan sponsor and/or participants can additionally be informed that the process provides only general educational information and cannot be relied on to provide advice to any particular plan regarding the selection or monitoring of any particular investment option, including specific target-date funds. In addition, the plan sponsor and/or participants can also be encouraged to seek investment advice, legal counsel or other assistance from appropriate, qualified advisers.

The system can further remind the plan sponsor and/or participants that investors should consider the investment objectives, risks, charges and expenses of a mutual fund carefully before investing, that this and other information can be contained in the fund's prospectus and summary prospectus, if available, which can be obtained by contacting their financial advisor, and that that investors should read the prospectus carefully before investing or sending money.

The system can further provide information to the plan sponsor and/or participants about risk. In particular, the system can provide information that an investor in a fund of funds, such as a target-date fund, can bear fees and expenses charged by the underlying funds in addition to the fees and expenses of the fund of funds, making the expenses of a fund of funds generally higher than a fund that primarily invests directly in equities or fixed-income securities. The principal value of a target-date fund is not guaranteed at any time, including the target date. The system can additionally recommend that the investor refer to the fund's applicable current prospectus for complete details.

Process 200 further includes the step 250 of documenting the process. This can include automatically saving the answers and score, as well as any recommendation, in memory. Additionally or alternatively, this step can provide an option to allow a user to document the selection and recommendation process by, for example, printing the questions, answers, score, and recommendation, along with any analysis provided to the user. This option can be used to help comply with any fiduciary obligations, for example, to show that the investment choice has been prudently selected. For example, on May 2009, Mary Shapiro, Chairman of the United States Securities and Exchange Commission, made the following statement: “Many target-date funds' underlying retirement plans actually establish their ‘glide paths’ based on the assumption that investors will continue to maintain their investments, and partially live off the proceeds, for a number of years following retirement. If that is the case, it must be plainly disclosed to investors.” As a result, if a retirement plan elects to use a “through” fund approach, the plan sponsor should communicate the plan's underlying assumptions to participants.

### 5. EXAMPLE 1

In an example process, a first question can be directed to information about the purpose of the savings plan. For example, the question can ask: “What is the purpose of your DC Plan?” The answer to this question can be worth, for example, 10 points. Two possible answers can include: “A. It's a vehicle to accumulate savings during a participant's working years” and “B. It's a vehicle to accumulate savings during a participant's working years and to distribute savings during retirement.”

A second question can be directed to predicted actions of participants in the savings plan. For example, the question can ask: “Based on your past experience, what action do you expect your DC plan participants to take with their assets at retirement?” The answer to this question can be worth, for example, 5 points. Two possible answers can include: “A Most of our participants will likely take their assets out of the DC plan upon retirement” and “B. Most of our participants will likely keep their assets in the DC plan during retirement.”

A third question can be directed to previous actions of the participants. For example, the question can ask: “What do your DC plan participants actually do with their DC plan assets within the first few years of their retirement date?” The answer to this question can be worth, for example, 10 points. Two possible answers can include: “A. Most of our participants take their assets out of the DC plan (e.g., IRA rollover, annuity purchase, etc.), or we don't yet have the plan data to determine this” and “B. Most of our participants keep their DC plan assets in plan following retirement.”

A fourth question can be directed to an administrator's ability to administer payment to participants. For example, the question can ask: “if your DC participants were interested in monthly income payments during retirement, does your record keeper have the ability to administer these types of payments to retirees?” The answer to this question can be worth, for example, 3 points. Two possible answers can include: “A. No, our record keeper cannot support monthly income payments to retirees” and “B. Yes, our record keeper can support monthly income payments to retirees at an acceptable fee structure.”

A fifth question Can be directed to the participants' knowledge to set up their own withdrawal plan. For example, the question can ask: “Do most of your DC plan participants have the knowledge to set up a withdrawal plan for their retirement income?” The answer to this question can be worth, for example, 5 points. TWO possible answers can include: A. No, the majority of participants are “delegators”]who don't have the time, interest or knowledge to set up a withdrawal plan” and “B. Yes, the majority of participants are sophisticated, and have the time, interest and knowledge to set up a withdrawal plan.”

A sixth question can be directed to the extent to which the participants can handle market losses in their accounts near or at retirement. For example, the question can ask: “How well can your plan participants handle market losses in their DC accounts near or at retirement?” The answer to this question can be worth, for example. 5 points. Two possible answers include: A. Not well: Most of our participants' savings are not positioned to handle market losses and cover retirement spending needs” and “B. Fairly well: Most of our participants have sufficient savings and appropriately allocated portfolios to cover retirement spending needs even in the event of market losses.”

A seventh question can be directed to whether participants also participate in other employer-sponsored retirement plans. For example, the question can ask: “Do your DC plan participants participate in other employer-sponsored retirement plans?” The answer to this question can be worth, for example, 10 points. Two possible answers can include: “A. No, most of our DC plan participants do not participate in other employer-sponsored plans (or we do not offer other plans)” and “B. Yes, most of our DC plan participants participate in another employer-sponsored plan (e.g., DB or similar plan).”

Once the questions are answered, the user can add the total number of points for the “A” answers and the total number of points for the “B” answers. In one embodiment, if the “A” answers are more dispositive of the need for a “to” fund, and if the total number of points for the “A” answers is greater than the total number of points for the “B” answers, the recommendation can be that the more appropriate choice for the plan is a “to” fund. If the “B” answers are more dispositive of the need for a “through” fund, and if the total number of points for the “B” answers is greater than the total number of points for the “A” answers, the recommendation can be that the more appropriate choice for the plan is a “through” fund.

In another embodiment, a type of investment vehicle for a specific retirement savings plan can be recommended based on the total number of points for the “A” or the “B” answers without considering their relative values. For example, if the total number of points in the “A” column equal to or greater than 24, the user can recommend that the more appropriate choice for the plan is a “to” fund without considering the total number of points in the “B” column.

Although this example was described ‘using certain weights, one of skill in the art will recognize that different weights may be chosen depending on the importance of the questions to the ultimate analysis, and depending on the types of questions that are provided to the user.

### 6. EXAMPLE 2

In another example process, the process can be configured so that a recommendation for either a “to” or “through” fund can be made after each response to each question. In some embodiments, this can result in a final recommendation being made without the need to answer every question. The questions are therefore arranged in order from most dispositive for a particular recommendation to least dispositive.

For example, most DC plans—401(k), 403(b), 457, etc.—were designed as vehicles to help participants save (accumulate) money for retirement, with the assumption that upon retirement the participants would take their money out of the plan via an IRA rollover (or other form of distribution) and then would have the option to develop an income or growth strategy—or use their money however they see fit. “To” target-date funds work well in this type of plan. However, some DC plans have begun to offer features that make it easy for participants to take automatic income from their target-date funds in their retirement years. “Through” target-date funds work well in this type of plan. Determining the ‘purpose’ of a DC plan will generally have a direct correlation to the most appropriate target-date fund for a plan. Accordingly, a first question can be directed to whether the purpose of the plan is to accumulate or deccumulate funds. For example, the question can ask: “What is the purpose of the retirement plan you're providing to your employees?” Two possible answers can include: “A. To accumulate assets that can be used as income for provide optionality) at retirement” and “B. To both accumulate assets and automatically provide lifetime income to participants during their retirement years (like a traditional pension plan).” If option A is selected, the user can be informed that a “to” fund may be more appropriate for the plan. If option B is selected, the user can be directed to proceed to the second question. Additional information, such as the reasoning or analysis behind the question, can be provided to the plan sponsor and/or participants in order to assist with answering this question.

Defining a user's objective and the ability of the recordkeeper to provide administrative services for participants during their retirement years is crucial to understanding what type of investment vehicle is more appropriate for a user's plan. In theory, if it is anticipated that participants will take their assets out of the plan within three years of retirement, then a target-date fund that becomes more conservative as it approaches the ‘retirement date’ (‘to’ fund) would help prepare the assets to leave the plan. Conversely, if it is anticipated that participants will ‘leave their assets in the plan’ in order to continue to grow them or produce income, then a target-date fund that manages 20 years or more past the “retirement date’ (‘Through’ fund) might be more appropriate. Knowing what the ‘goal’ is for expected participant behavior during their post-retirement years—and aligning this to the recordkeeper's capabilities—is useful. Further, the Department of Labor notes that aligning a plan sponsor's goals to that of the target-date fund is consistent with the fiduciary process for selecting target-date funds. Accordingly, an analysis of the knowledge and interest of the fiduciaries is useful, and a second question can be directed to retiree goals and administrative services. For example, this question can ask: “What is the assumed action your participants will take upon retirement?” Two possible answers can include: “A. Take assets out of the plan. (I assume I will not have fiduciary liability or administrative responsibility after participants retire.)” and “B. Keep money in the plan. (I will administer monthly income checks and/or provide appropriate growth investments for post-retirees, which might reduce my administrative fees. My record keeper can support this option.)” If option A is selected, the user can be informed that a “to” fund may be more appropriate for the plan. If option B is selected, the user can be directed to proceed to the third question. Additional information, such as the reasoning or analysis behind the question, can be provided to the plan sponsor and/or participants in order to assist with answering this question.

Generally speaking, if participants take all of their money out of a DC plan with three years of retirement, a target-date fund that manages ‘to’ retirement may be more suitable. Selecting a target date fund that manages ‘to’ retirement may reduce volatility in the crucial 5- to 10-year period leading up to retirement. This may also reduce sequencing risk for participants who retire in the wrong market cycle. However, if participants leave all the money in the plan after they retire (because they don't need it for income purposes) and/or take automatic withdrawals from the plan for the rest of their lives, a target date fund that manages ‘through’ retirement may be more suitable. A target-date fund that manages ‘through’ retirement might provide participants a greater chance of not outliving their savings. It has been shown that 81% of participants take all of their money out of the plan within the first three years. Accordingly, a third question can be directed to post-retirement behavior. For example, this question can ask: “What do the majority of participants actually do with their DC assets within the first three years after retirement?” Three possible answers can include: “A. Take money out of the plan (IRA rollover, cash out, annuity purchase, etc.)”, “B. Leave money in the plan (to continue growth potential and/or take periodic distributions)”, and “C. Unknown (most participants have not reached retirement or don't stay employed until retirement age).” if options A or C are selected, the user can be informed that a “to” fund may be more appropriate for the plan. If option B is selected, the user can be directed to proceed to the fourth question. Additional information, such as the reasoning or analysis behind the question, can be provided to the plan sponsor and/or participants for this question in order to assist with answering this question.

One type of participant behavior includes the participants leaving their money in the plan and letting it grow for at least 10 years. There are few potential administrative challenges in this plan. Another type of participant behavior includes the participants leaving the money in the plan and beginning to take automatic withdrawals until death. Potential administrative challenges include that the plan document must allow for automatic withdraws and that cost should not be an issue. Another type of participant behavior includes the participants perform an in kind transfer' of the target-date fund to their IRA. Potential administrative challenges include that an ‘in kind transfer’ allows the participant to accomplish the following: a. stay invested during the IRA rollover process (many record keepers require a complete liquidation and then send an IRA rollover check for the benefit of the participant); and b. maintain the existing institutionally priced target date fund into the individual's IRA. If the participant's goal is to ‘roll over’ their target-date funds from their 401(k) to an then the 401(k) administrator should have the ability to process in kind transfers.' This feature would allow the participant to maintain their exact glide path, asset allocation and fee structure—without being out of the market during the transfer. This feature should be in place if a plan sponsor is offering a “through” target-date fund.

Accordingly, a fourth question can be directed to complexity and administrative considerations, and more particularly to assessing a record keeper's ability to provide income payments to retirees. For example, a sub-part to the fourth question can ask: “A. Does your plan allow for periodic (automatic) monthly withdrawals after reaching age 59½ and/or separation from employment?” If “yes” is selected for this sub-part, a follow-up question can ask: “B. Is there an administrative fee per distribution (check fee), and is the fee structure and frequency accommodative for participants who wish to take systematic (monthly) withdrawals?” If “no” is selected for sub-part A, the user can be informed that a “to” fund may be more appropriate for the plan. If “yes” is selected for sub-part B, the user can be directed to proceed to the fifth question. Additional information, such as the reasoning or analysis behind the question, can be provided to the plan sponsor and/or participants for this question in order to assist with answering this question.

“Many target-date funds' underlying retirement plans actually establish their glide paths based on the assumption that investors will continue to maintain their investments, and partially live off the proceeds. If that is the case, it must be plainly disclosed to investors.” (Mary Schapiro, Chairman, Securities & Exchange Commission, as quoted in the Wall Street Journal, May 5, 2009.) It is known that individuals focus on the product attribute that is easiest to evaluate. (Hsee (1996); Johnson et al (2003); Cox and Payne (2005).) Accordingly, a fifth question can be directed to participant investment knowledge, and more particularly to factors to consider if participants plan to take withdrawals (income) from a target date fund. For example, a sub-part to the fifth question can ask: “A. If you plan on utilizing a ‘through’ target date fund, do most of your participants have the investment acumen to set up a withdrawal plan during their retirement years using their existing target date fund as the source of income?” If “yes” is selected for this sub-part, a follow-up question can ask: “B. are you educating your participants about their additional responsibilities?” If “no” is selected for sub-part A and/or sub-part B, the user can be informed that a “to” fund may be more appropriate for the plan. If “yes” is selected for sub-part A and sub-part B, the user can be directed to proceed to the sixth question. Additional information, such as the reasoning or analysis behind the question, can be provided to the plan sponsor and/or participants for this question in order to assist with answering this question.

Commonly held theory states that pain associated with a $100 loss has twice the effect of the pleasure of winning $100. (Kahneman and Tversky (1979); Tversky and Kahneman (1992).) In 2008, 2010 target-date funds posted a range of losses from 9% to 41% (Morningstar, 2009). Market sequencing risk is the risk that participants face if they retire in the wrong market cycle, such as 2008. During this market downturn, for the 2008 calendar year, the worst-performing 2010 target date fund was down 41%. Therefore, participants who were invested in that fund and who retired in January of 2009 would have only been able to purchase 59% of the ‘income units’ they could have purchased had they retired a year earlier. The Department of Labor notes that, according the final QDIA regulations published in 2007, a QDIA must be diversified so as to minimize the risk of large losses. Accordingly, a sixth question can be directed to capacity for risk and in particular to capacity for market sequencing risk. For example, this question can ask: “With a long-term time horizon, investors may be able to better recover from a market correction. When you think of participants who are approaching retirement age, which statement describes them?” Answering yes to such a question means that solving for ‘market sequencing risk’—to minimize the downside impact to participants who retire in the wrong market cycle (sequence)—is important. Two possible answers can include: “A. They can stomach a significant loss when they retire, because they saved enough to get them through a difficult market environment” and “B. They cannot stomach a significant loss when they retire, because they have not done a good job saving and/or it will cause them too much anxiety.” If option “B” is selected, the user can be informed that a “to” fund may be more appropriate for the plan. If option “A” is selected, a “through” fund may be recommended as more appropriate for the plan, and the user can be further directed to proceed to the seventh question. Additional information, such as the reasoning or analysis behind the question, can be provided to the plan sponsor and/or participants for this question in order to assist with answering this question.

Guaranteed lifetime income is another factor to be considered in recommending a type of investment vehicle. If participants are offered other retirement plans that, when combined with social security, replace most of a participant's income, then a ‘through° fund might be more appropriate. It has been determined that guaranteed lifetime income boosts happiness (and maybe even longevity). (Panis (2003).) Therefore, if the company does not offer a defined benefit plan, or other guaranteed lifetime income plan, then giving participants the ability to purchase the greatest amount of guaranteed lifetime units (annuity or other forms) would point the user in the direction of a ‘to’ target date fund. Accordingly, a seventh question can be directed to a guaranteed lifetime income. For example, this question can ask: “Does your company offer additional retirement plans, such as defined benefit plans, that provide guaranteed lifetime income to your participants?” Two possible answers can include: “yes” and “no”. If “yes” is selected, the plan sponsor can recommend that a “through” fund may be more appropriate for the plan. If “no” is selected, the plan sponsor can recommend that a “to” fund may be more appropriate for the plan. Additional information, such as the reasoning or analysis behind the question, can be provided to the plan sponsor and/or participants for this question in order to assist with answering this question.

The process can additionally provide an option for a user to input any other considerations not specifically addressed by the above questions, such as any unique concerns for the participant or plan sponsor.

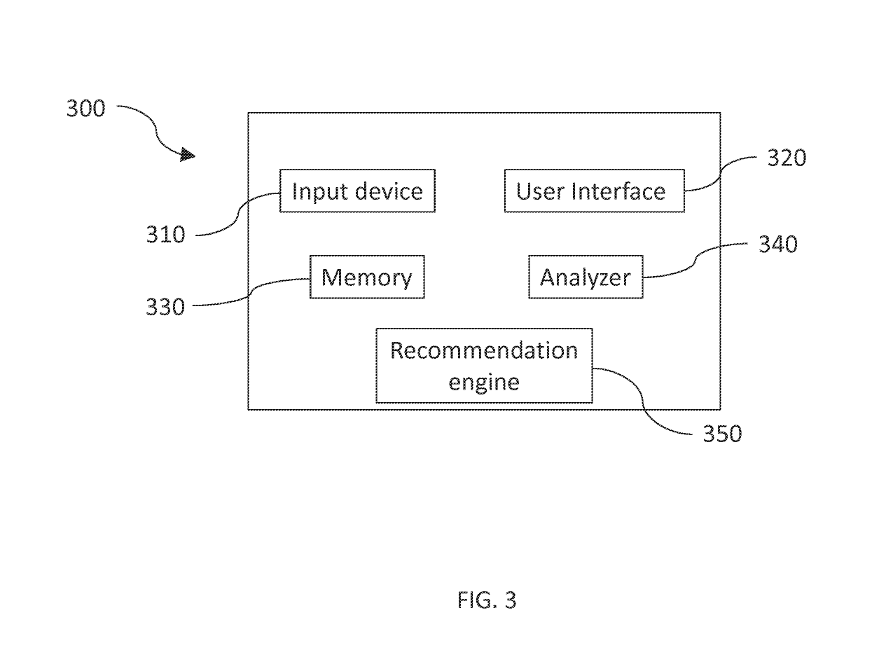

FIG. 3 depicts an example computer system 300 in which embodiments of the present invention may be implemented. System 300 includes an input device 310, a user interface 320, a memory 330, an analyzer 340, and a recommendation engine 350. Computer system 300 can be, but is not limited to, a personal computer, mobile device such as a mobile telephone, workstation, embedded system, game console, television, or set-top box. Input device 310 enables a user to input data into the system and can including, for example, one or more of a keyboard, mouse, touchscreen interface, or any other suitable input device. User interface 320 can output information to the user and can, for example, be a web application interface, or may be a standalone application operating on a client device. In one embodiment, information can be outputted via a printer, speakers, or other suitable output device. Memory 330 can store information, such as information regarding available target-date funds and/or the user data. Analyzer 340 can include, for example, one or more processors to analyze received data. Recommendation engine 350 can, for example, provide a recommendation based on received data. In some embodiments, one or more of the elements are operatively connected within a single housing. In some embodiments, one or more of the elements are operatively connected within separate housings.

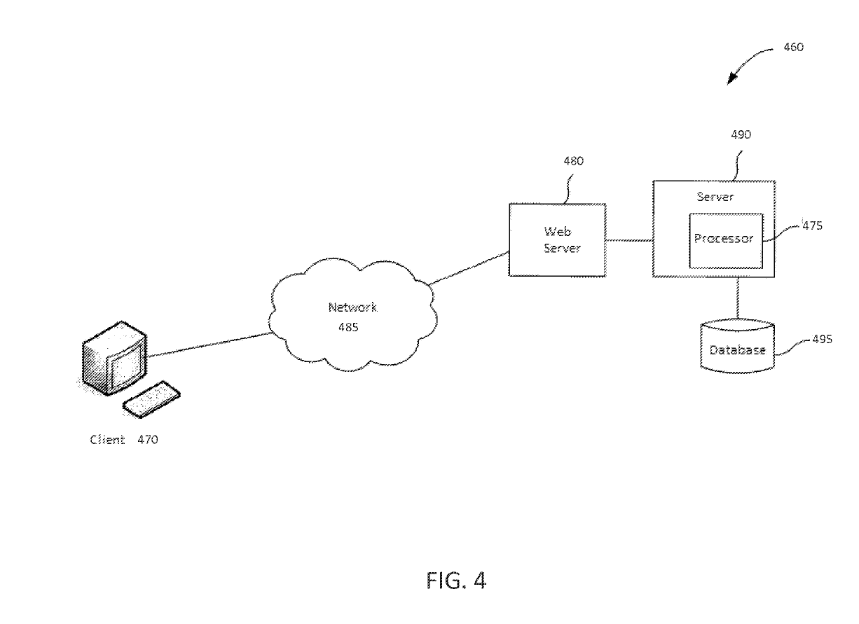

In an embodiment, the operations of the above systems are split among multiple computing devices in a client-server environment. FIG. 4 depicts an embodiment of such a computer system 460 having a communications interface over a network. System 460 includes a client 470, web server 480, server 490, and database 495. Client 470 is coupled to web server 480 over a network 485. Network 485 can be any one or more networks of any type including, but not limited to, local area networks, medium area networks, or wide-area networks, such as, the Internet. In one example, client 470 can include a browser that communicates over a network 485 with web server 480, which is coupled to server 490. The web server can include, but is not limited to, a device having one or more processors and memory for executing and storing instructions. The web server can include, but is not limited to, a processor, memory, graphical user interface display, or a combination thereof. The web server can include multiple processors or multiple shared or separate memory components. For example, the web server can include a cluster computing environment or server farm

### 7EXAMPLE COMPUTER SYSTEM IMPLEMENTATION

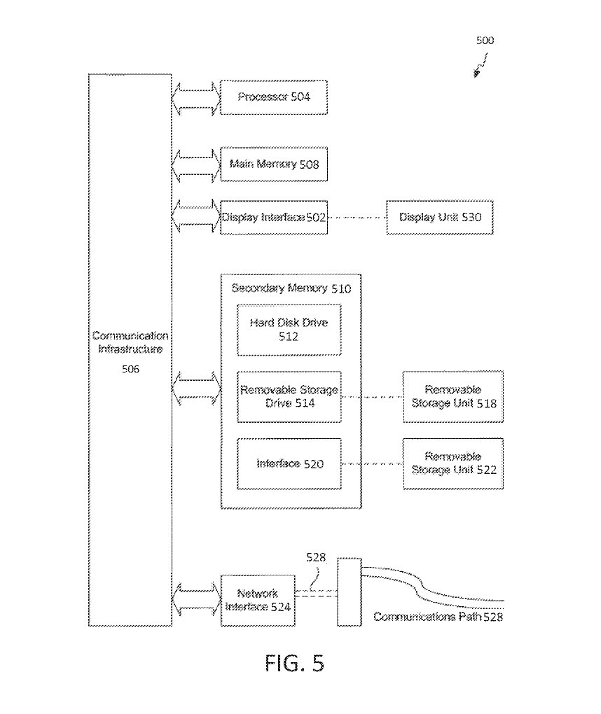

FIG. 5 illustrates an example computer system 500 in Which embodiments of the present invention, or portions thereof, can be implemented as computer-readable code. For example, the process illustrated by the flowchart of FIG. 2 can be implemented in system 500. Various embodiments of the invention are described in terms of this example computer system 500. After reading this description, it will become apparent to a person skilled in the relevant art how to implement the invention using other computer systems and/or computer architectures.

Computer system 500 includes one or more processors, such as processor 504. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive 512, a removable storage drive 514, and/or a memory stick. Removable storage drive 514 may include a floppy disk drive, a magnetic tape drive, an optical disk drive, a flash memory, or the like. The removable storage drive 514 reads from and/or writes to a removable storage unit 518 in a well-known manner. Removable storage unit 518 may include a floppy disk, magnetic tape, optical disk, etc. that is read by and written to by removable storage drive 514. As will be appreciated by persons skilled in the relevant art(s), removable storage unit 518 includes a computer readable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 that allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals that may be electronic, electromagnetic, optical, or other signals capable of being received by communications interface 524. These signals are provided to communications interface 524 via a communications path 526. Communications path 526 carries signals and may be implemented using wire or cable, fiber optics, a phone line, a cellular phone link, an RF link or other communications channels.

In this document, the terms “computer program storage medium” and “computer readable storage medium” are used to generally refer to media such as removable storage unit 518, removable storage unit 522, and a hard disk installed in hard disk drive 512. Computer program medium and computer readable storage medium can also refer to memories, such as main memory 508 and secondary memory 510, which can be memory semiconductors (e.g. DRAMs, etc.).

Computer programs (also called computer instructions or control logic) are stored in storage media such as main memory 508 and/or secondary memory 510. Computer programs may also be received via communications interface 524. Such computer programs, when executed, enable computer system 500 to implement embodiments of the present invention as discussed herein. In particular, the computer programs, when executed, enable processor 504 to implement the processes of embodiments of the present invention, such as the steps in the process illustrated by the flowchart of FIG. 2, discussed above or the implementations illustrated by FIG. 3 or 4. Accordingly, such computer programs represent controllers of the computer system 700.

Embodiments of the invention are also directed to computer program products including software stored on any computer readable storage medium. Such software, when executed in one or more data processing devices, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and non-storage communication mediums (e.g., Wired and wireless communications networks, local area networks, wide area networks, intranets, etc.).

The computerized system and process described herein can provide assistance to plan sponsors and participants in choosing a type of investment vehicle for a specific retirement savings plan. For example, it can assist understanding of the differences between “to” and “through” target-date thuds, evaluate whether a “to” or “through” target-date fund is most appropriate for a given DC plan, and narrow down the universe of target-date funds to only the most suitable funds.

### 8. CONCLUSION

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. In addition, the breadth and scope of the present invention should not be limited by any of the above-described exemplary embodiments.

1. A computerized process for determining and recommending a type of target-date fund for a retirement savings plan, the process comprising:
receiving, by a computing device, data from a user including at least the following:
(a) information about the purpose of the savings plan,
(b) predicted actions of participants in the savings plan,
(c) previous actions of the participants,
(d) an administrator's ability to administer payment to participants,
(e) the participants' knowledge, to set up their own withdrawal plan,
(f) the extent to which the participants can handle market losses in their accounts near or at retirement, and
(g) whether participants also participate in other employer-sponsored retirement plans;
determining, by the computing device, a recommended type of target-date fund based at least in part on the received data; and
outputting, by the computing device, the recommended type of target-date fund for presentation to the user.

2. The process of claim 1, wherein the types of target-date funds include “to” funds and “through” funds.

3. The process of claim 1, wherein the receiving act comprises receiving data input by a plan sponsor.

4. The process of claim 1, wherein the receiving comprises receiving data input by a plan participant.

5. The process of claim 1, further comprising:
recommending a specific target date fund based on the received data.

6. A computer readable storage medium having instructions stored thereon that, when executed by a computing device, cause the computing device to perform operations for determining and recommending a type of target-date fund for a retirement savings plan, the operations comprising:
receiving data from a user including at least the following:
(a) information about the purpose of the savings plan,
(b) predicted actions of participants in the savings plan,
(c) previous actions of the participants,
(d) an administrator's ability to administer payment to participants,
(e) the participants' knowledge to set up their own withdrawal plan,
(f) the extent to which the participants can handle market losses in their accounts near or at retirement, and
(g) whether participants also participate in other employer-sponsored retirement plans:
determining a recommended type of target-date fund based at least in part on the received data; and
outputting the recommended type of target-date fund for presentation to the user.

7. The computer readable storage medium of claim 6, the operations further comprising:
recommending a specific target date fund based on the received data.

8. The computer readable storage medium of claim 6, wherein the types of target-date funds include “to” funds and “through” funds.

9. A system for determining and recommending a type of target-date fund for a retirement savings plan, the system comprising:
a processor;
a computer interface; and
a memory, the memory having stored thereon instructions that when executed by the processor cause the processor to perform operations including:
receiving data from a user including at least the following:
(a) information about the purpose of the savings plan,
(b) predicted actions of participants in the savings plan,
(c) previous actions of the participants,
(d) an administrator's ability to administer payment to participants,
(e) the participants' knowledge to set up their own withdrawal plan,
(f) the extent to which the participants can handle market losses in their accounts near or at retirement, and
(g) whether participants also participate in other employer-sponsored retirement plans;
determining a recommended type of target-date fund based at least in part on the received data; and
outputting the recommended type of target-date fund for presentation to the user.

10. The system of claim 9, the operations further including:
receiving data from a user including information about whether a predicted action the plan participants will take upon retirement is to take assets out of the plan or whether the predicted action is to keep money in the plan;
providing a recommendation for a “to” target-date fund when the received data indicates that the predicted action is to take assets out of the plan; and
requesting additional information from the user when the received data indicates that the predicted action is to keep money in the plan.

11. A computerized process for determining and recommending a type of target-date fund for a retirement savings plan, the process comprising:
receiving data from a user including at least information about whether a primary purpose of the target-date fund is to accumulate funds that can be used as income or provide optionality at retirement, or whether the primary purpose of the target-date fund is to both accumulate assets and automatically provide lifetime income to participants during their retirement years;
providing a recommendation for a “to” target-date fund when the received data indicates that the primary purpose of the target-date fund is to accumulate funds that can be used as income or provide optionality at retirement; and
requesting additional information from the user when the received data indicates that the primary purpose of the target-date fund is to both accumulate assets and automatically provide lifetime income to participants during their retirement years.

12. The process of claim 11, the process further comprising:
receiving data from a user including information about whether a predicted action the plan participants will take upon retirement is to take assets out of the plan or whether the predicted action is to keep money in the plan;
providing a recommendation for a “to” target-date fund when the received data indicates that the predicted action is to take assets out of the plan; and
requesting additional information from the user when the received data indicates that the predicted action is to keep money in the plan.

13. A computer readable storage medium having instructions stored thereon that, when executed by a computing device, cause the computing device to perform operations for determining and recommending a type of target-date fund for a retirement savings plan, the operations comprising:
receiving data from a user including at least information about whether a primary purpose of the target-date fund is to accumulate funds that can be used as income or provide optionality at retirement, or whether the primary purpose of the target-date fund is to both accumulate assets and automatically provide lifetime income to participants during their retirement years;
providing a recommendation for a “to” target-date fund when the received data indicates that the primary purpose of the target-date fund is to accumulate funds that can be used as income or provide optionality at retirement; and
requesting additional information from the user when the received data indicates that the primary purpose of the target-date fund is to both accumulate assets and automatically provide lifetime income to participants during their retirement years.

14. The computer readable storage medium of claim 13, the operations further comprising:
receiving data from a user including information about whether a predicted action the plan participants will take upon retirement is to take assets out of the plan or whether the predicted action is to keep money in the plan;
providing a recommendation for a “to” target-date fund when the received data indicates that the predicted action is to take assets out of the plan; and
requesting additional information from the user when the received data indicates that the predicted action is to keep money in the plan.

15. A system for determining and recommending a type of target-date fund for a retirement savings plan, the system comprising:
a processor;
a computer interface; and
a memory, the memory having stored thereon instructions that when executed by the processor cause the processor to perform operations including:
receiving data from a user including information about whether a primary purpose of the target-date fund is to accumulate funds that can be used as income or provide optionality at retirement, or whether the primary purpose of the target-date fund is to both accumulate assets and automatically provide lifetime income to participants during their retirement years;
outputting, via the computer user interface, a recommendation for a “to” target-date fund when the received data indicates that the primary purpose of the target-date fund is to accumulate funds that can be used as income or provide optionality at retirement; and
requesting additional information from the user when the received data indicates that the primary purpose of the target-date fund is to both accumulate assets and automatically provide lifetime income to participants during their retirement years.

16. The system of claim 15, the operations further including:
receiving data from a user including information about whether a predicted action the plan participants will take upon retirement is to take assets out of the plan or whether the predicted action is to keep money in the plan;
providing a recommendation for a “to” target-date fund when the received data indicates that the predicted action is to take assets out of the plan; and
requesting additional information from the user when the received data indicates that the predicted action is to keep money in the plan.
